(19) United States
(12) Patent Application Publication
(10) Pub. No.: US 2023/0140487 A1
(43) Pub. Date: May 4, 2023

(54) BASE STATION, COMMUNICATION METHOD, AND COMMUNICATION PROGRAM

(71) Applicant: NIPPON TELEGRAPH AND TELEPHONE CORPORATION, Tokyo (JP)

(72) Inventors: Akira KISHIDA, Musashino-shi (JP); Yasuhiko INOUE, Musashino-shi (JP); Kengo NAGATA, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 17/910,912

(22) PCT Filed: Mar. 17, 2020
(86) PCT No.: PCT/JP2020/011816

§ 371 Date: Sep. 12, 2022

(51) Int. Cl. H04W 28/26; H04W 74/08

(52) U.S. Cl. CPC H04W 28/26; H04W 74/0816

(57) ABSTRACT

A base station serving as a second base station includes a wireless signal processing unit capable of using a first channel held in common with another base station serving as a first base station. The wireless signal processing unit is configured to execute first cooperative processing in a case of the first base station acquiring a transmission right for the first channel that is a primary channel. The first cooperative processing includes, on the basis of the second base station acquiring a transmission right for a second channel that is a secondary channel of the second base station, deciding to transmit by the second channel.

### TECHNICAL FIELD

An embodiment relates to a base station, a communication method, and a communication program.

### BACKGROUND ART

A wireless LAN base station and a terminal apparatus access a channel using CSMA/CA (Carrier Sense Multiple Access with Collision Avoidance) to transmit wireless signals. In CSMA/CA, the base station and the terminal apparatus stand by for an amount of time defined by an access parameter, and transmit wireless signals upon having confirmed by carrier sensing that the channel is not in use by another terminal apparatus or the like.

A primary channel that is used foremostly when transmitting wireless signals, and a secondary channel that is usable in conjunction with the primary channel, are installed in the base station. Ina case in which confirmation is made by carrier sensing that neither the primary channel nor the secondary channel is in use, the base station can transmit wireless signals using both the primary channel and the secondary channel in conjunction.

### CITATION LIST

### Non Patent Literature

NPL 1: IEEE Std 802.11-2016, “10.22.2.5 EDCA channel access in a VHT or TVHT BSS”, 7 Dec. 2016

### SUMMARY OF THE INVENTION

### Technical Problem

However, in a case in which the same channel is set as the primary channel among a plurality of base stations, a base station that fails to acquire a transmission right for the primary channel does not transmit wireless signals, regardless of whether or not the secondary channel is in use. Thus, in a case in which the same channel is set as the primary channel in a plurality of base stations, there is a possibility that the secondary channel will not be used even if usable. That is to say, there is room for consideration regarding efficiently using channels among of plurality of base stations.

The present invention has been made in view of the foregoing, and it is an object thereof to provide a wireless communication environment in which channels can be efficiently used among a plurality of base stations.

### Means for Solving the Problem

In one aspect, a base station serving as a second base station includes a wireless signal processing unit capable of using a first channel held in common with another base station serving as a first base station. The wireless signal processing unit is configured to execute first cooperative processing in a case of the first base station acquiring a transmission right for the first channel that is a primary channel. The first cooperative processing includes, on the basis of the second base station acquiring a transmission right for a second channel that is a secondary channel of the second base station, deciding to transmit by the second channel.

### Effects of the Invention

According to the embodiment, a wireless communication environment can be provided in which channels can be efficiently used among a plurality of base stations.

### BRIEF DESCRIPTION OF DRAWINGS

FIG. 1 is a block diagram illustrating a configuration of a communication system according to an embodiment.

FIG. 2 is a block diagram illustrating a hardware configuration of a base station according to the embodiment.

FIG. 3 is a block diagram illustrating a hardware configuration of a terminal apparatus according to the embodiment.

FIG. 4 is a conceptual diagram showing a cooperative base station management table stored in the base station according to the embodiment.

FIG. 5 is a flowchart showing negotiation processing executed between base stations according to the embodiment.

FIG. 6 is a conceptual diagram showing a cooperative base station management table generated by negotiation processing executed between base stations according to the embodiment.

FIG. 7 is a flowchart showing transmission processing of data executed among a plurality of base stations according to the embodiment.

FIG. 8 is a timing chart showing a case of cooperative transmission processing being executed, out of the transmission processing of data executed among the plurality of base stations according to the embodiment.

FIG. 9 is a timing chart showing a case of the cooperative transmission processing not being executed, out of the transmission processing of data executed among the plurality of base stations according to the embodiment.

### DESCRIPTION OF EMBODIMENTS

An embodiment will be described below with reference to the Figures. Note that in the description below, components that have the same functions and configurations are denoted by common reference signs. Also, in a case of distinguishing a plurality of components having common reference signs, distinguishment will be made by further reference signs added following the common reference signs (e.g., a hyphen and numeral, such as “-1” or the like).

### 1. Embodiment

### 1.1 Configuration

A configuration of a wireless communication system according to the embodiment will be described.

### 1.1.1 Wireless Communication System

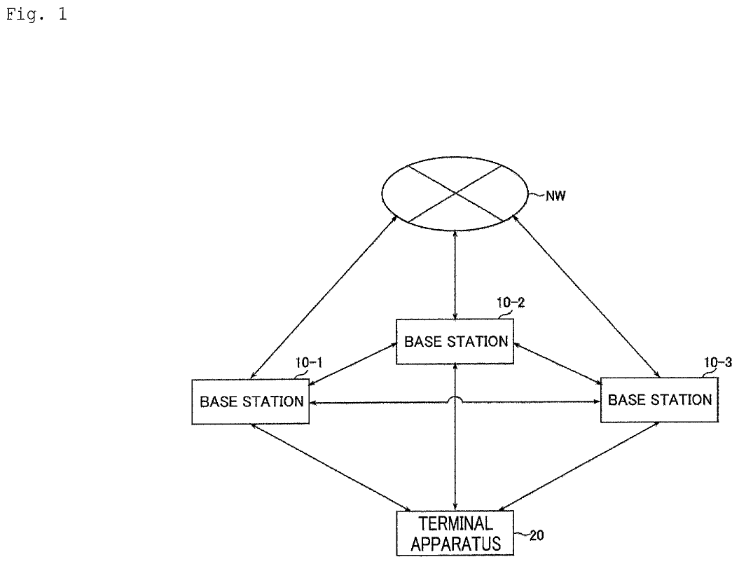

FIG. 1 is a block diagram illustrating an example of the configuration of the wireless communication system according to the embodiment.

The wireless communication system 1 is provided with a plurality of base stations 10-1, 10-2, and 10-3, and a terminal apparatus 20, as illustrated in FIG. 1. The plurality of base stations 10-1 to 10-3 each connects a network NW and the terminal apparatus 20, and functions as an access point for the terminal apparatus 20 to access the network NW. Each of the plurality of base stations 10-1 to 10-3 has a service area that is set in advance, and is capable of communicating with terminals within this service area.

Also, the plurality of base stations 10-1 to 10-3 are capable of communicating with each other, and can execute cooperative data transmission in a frequency domain, by sharing information of frequency bands (channels) and so forth used for communication. Details of cooperative transmission processing of data in the frequency domain will be described later.

The terminal apparatus 20 is a wireless terminal apparatus such as a smartphone, PC (Personal computer), or the like, for example. The terminal apparatus 20 is configured to be capable of exchanging data with the network NW via the plurality of base stations 10-1 to 10-3. The example in FIG. 1 illustrates a case of the terminal apparatus 20 belonging to the service areas of all of the plurality of base stations 10-1 to 10-3.

### 1.1.2 Base Station

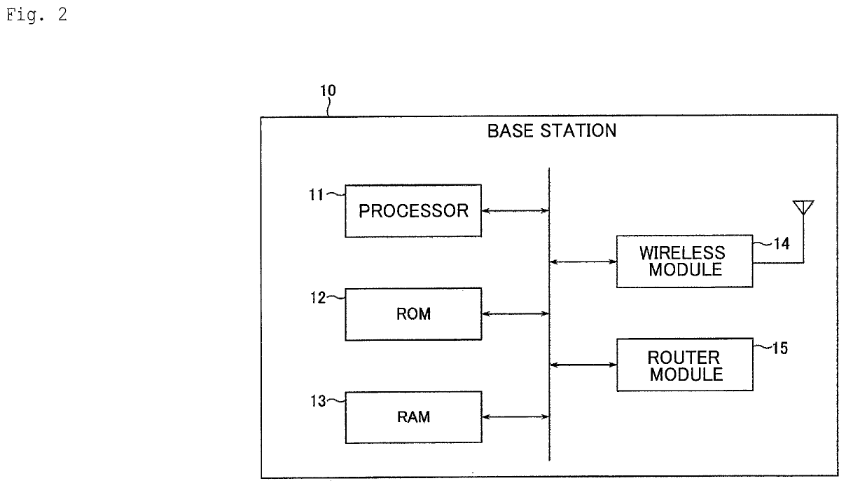

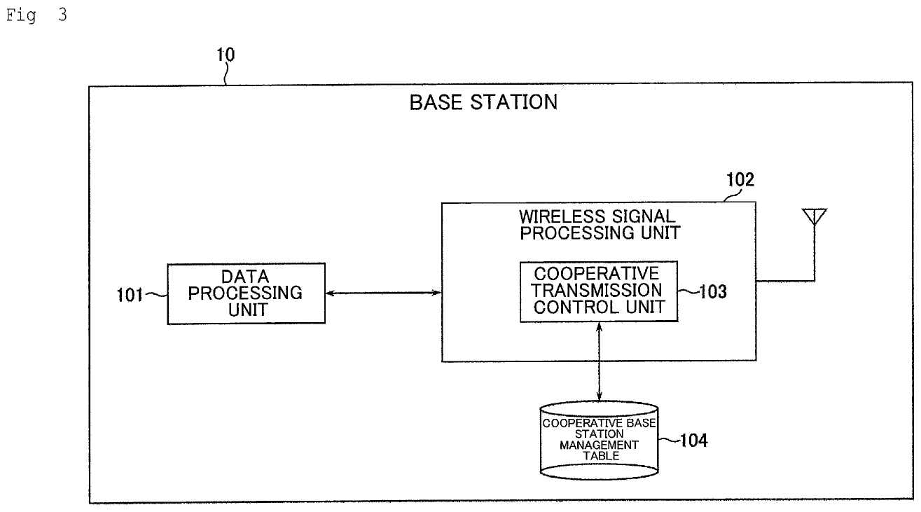

FIG. 2 and FIG. 3 are block diagrams illustrating an example of a hardware configuration and a functional configuration of the base station according to the embodiment, respectively. Note that the plurality of base stations 10-1 to 10-3 in FIG. 1 may have the same configuration. FIG. 2 and FIG. 3 exemplify the configuration of any one of the plurality of base stations 10-1 to 10-3 as the base station 10.

First, the hardware configuration of the base station 10 will be described with reference to FIG. 2.

As illustrated in FIG. 2, the base station 10 is provided with a processor 11, a ROM (Read only memory) 12, a RAM (Random access memory) 13, a wireless module 14, and a router module 15.

The processor 11 is a processing device that controls the entire base station 10. The processor 11 is a CPU (Central processing unit), for example, but is not limited to this, and an ASIC (Application specific integrated circuit) or the like may be used instead of a CPU. The ROM 12 is a nonvolatile semiconductor memory, for example, and holds firmware and various types of programs necessary for operation of the base station 10. The RAM 13 is a volatile semiconductor memory, for example, and is used as a work area for the processor 11.

The wireless module 14 is a circuit used for exchange of data by wireless signals, and is connected to an antenna. The router module 15 is provided for the base station 10 to communicate with a server that is omitted from illustration within the network NW, for example.

Next, the functional configuration of the base station 10 will be described with reference to FIG. 3.

As illustrated in FIG. 3, the base station 10 functions as a computer provided with a data processing unit 101 and a wireless signal processing unit 102. The data processing unit 101 and the wireless signal processing unit 102 are functional blocks for performing data communication on the basis of the OSI (Open systems interconnection) reference model. Communication functions in the OSI reference model are divided into seven layers (Layer 1: physical layer, Layer 2: data link layer, Layer 3: network layer, Layer 4: transport layer, Layer 5: session layer, Layer 6: presentation layer, Layer 7: application layer). The data link layer includes an LLC (Logical Link Control) layer and a MAC (Media access Control) layer. In the present specification, Layer 3 to Layer 7 will be referred to as “higher layers”, with the data link layer that is Layer 2 as a reference.

The data processing unit 101 executes processing corresponding to the LLC layer and higher layers on input data. For example, the data processing unit 101 outputs data input from the network NW to the wireless signal processing unit 102. The data processing unit 101 also outputs data input from the wireless signal processing unit 102 to the network NW.

The wireless signal processing unit 102 executes MAC layer and physical layer processing with regard to the input data, and exchanges data between the base station 10 and the terminal apparatus 20, or between the base station 10 and other base stations 10, using wireless communication. For example, the wireless signal processing unit 102 creates wireless frames using data input from the data processing unit 101, converts the wireless frames into wireless signals, and sends the wireless signals out to the terminal apparatus 20 or another base station 10 via the antenna. The wireless signal processing unit 102 also converts wireless signals received via the antenna into wireless frames, and outputs the data included in the wireless frames to the data processing unit 101.

Now, the wireless signal processing unit 102 may perform control in accordance with a degree of priority in transmission, by allocating wireless frames to a plurality of transmission queues. For example, the wireless signal processing unit 102 may have a plurality of transmission queues AC_LL, AC_VO, AC_VI, AC_BE, and AC_BK, for each access category (AC). The transmission queue AC_LL is a queue for holding wireless frames categorized into LL (Low latency). The transmission queue AC_VO is a queue for holding wireless frames categorized into VO (Voice). The transmission queue AC_VI is a queue for holding wireless frames categorized into VI (Video). The transmission queue AC_BE is a queue for holding wireless frames categorized into BE (Best effort). The transmission queue AC_BK is a queue for holding wireless frames categorized into BK (Background). The wireless signal processing unit 102 inputs the wireless frames into the corresponding transmission queues, in accordance with the category of the data recorded in the wireless frames.

The wireless signal processing unit 102 confirms by carrier sensing, for each access category, that there is no transmission of wireless signals by other base stations or the like on the channel to be used, and waits for transmission in accordance with an amount of time defined by access parameters set for each access category. The access parameters are assigned such that transmission of wireless signals are prioritized in a relative manner in the order of LL, VO, VI, BE, and BK, for example. If there is no transmission of wireless signals by another base station or the like while waiting for transmission, the wireless signal processing unit 102 assumes that the own station has acquired the transmission right for the channel, takes the wireless frame out of the corresponding transmission queue, and thereafter converts the wireless frame into wireless signals on the basis of the predetermined channel and performs transmission thereof.

Note that in a case of having acquired the transmission right for a particular channel, the wireless signal processing unit 102 can transmit wireless signals using this particular channel and another channel regarding which the transmission right has been further acquired, in conjunction. In the following description, the above-described “particular channel” and “other channel” will be referred to as “primary channel” and “secondary channel”, respectively, and will be distinguished as necessary.

The wireless signal processing unit 102 includes a cooperative transmission control unit 103. The cooperative transmission control unit 103 controls cooperative transmission processing in the frequency domain that is carried out between the base station 10 that is the own station, and other base stations 10, on the basis of a cooperative base station management table 104. Cooperative transmission processing is processing in which, among a plurality of base stations regarding which the same channel is set as the primary channel, a base station that succeeded in acquisition of the transmission right for the primary channel (master station) and a base station that failed in acquisition of the transmission right (slave station) use channels of different bands from each other to cooperative execute OFDMA (Orthogonal Frequency Division Multiple Access).

Specifically, prior to transmission processing of data to the terminal apparatus 20, the cooperative transmission control unit 103 executes negotiation processing with other base stations 10 capable of communication (cooperation candidate base stations), and decides a base station 10 capable of executing cooperative transmission processing (cooperative base station). Information regarding cooperation candidate base stations and cooperative base stations is stored in the cooperative base station management table 104 within the base station 10, for example.

Also, when the own station becomes the master station, the cooperative transmission control unit 103 generates an invite signal requesting a slave station to participate in cooperative transmission processing, on the basis of the cooperative base station management table 104. Conversely, in a case in which the own station becomes a slave station, upon receiving an invite signal from the master station, the cooperative transmission control unit 103 determines whether or not to participate in the cooperative transmission processing requested from the master station, and generates response signals including the determination results thereof.

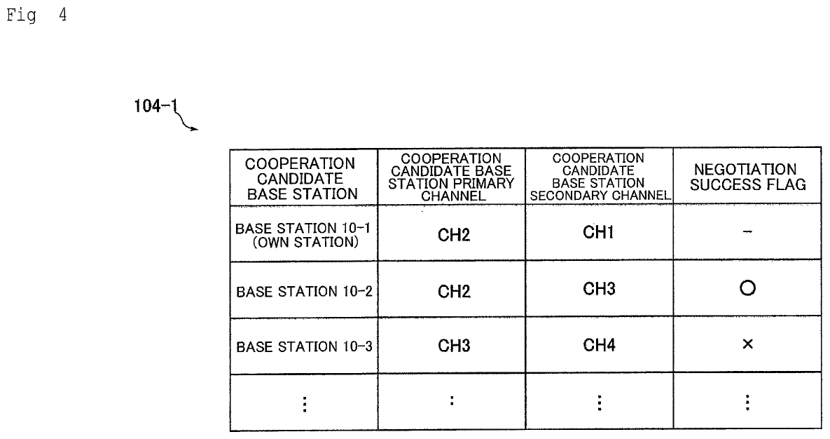

FIG. 4 is a conceptual diagram showing a cooperative base station management table stored in a base station according to the embodiment. FIG. 4 showing a conceptual diagram of a cooperative base station management table 104-1 in the base station 10-1, as an example of the cooperative base station management table 104.

As illustrated in FIG. 4, identification information of cooperation candidate base stations, the primary channel and the secondary channel used by the cooperation candidate base stations, and a negotiation success flag, are stored in the cooperative base station management table 104-1 in a cooperative manner. The negotiation success flag is information indicating whether or not negotiation with the cooperation candidate base station was successful (whether or not the cooperation candidate base station was registered as a cooperative base station as a result of the negotiation processing).

In the example in FIG. 4, the first row stores that the base station 10-1 that is the own station uses channel CH2 as the primary channel and uses channel CH1 as the secondary channel.

The second row stores that the base station 10-2 uses channel CH2 as the primary channel and uses channel CH3 as the secondary channel. Also stored in the negotiation success flag column is that negotiation with the base station 10-2 was successful, and information indicating that the base station 10-2 has been registered as a cooperative base station of the base station 10-1 (indicated by a “circle” in FIG. 4).

The third row stores that the base station 10-3 uses channel CH3 as the primary channel and uses channel CH4 as the secondary channel. Also stored in the negotiation success flag column is that negotiation with the base station 10-3 was not successful, and information indicating that the base station 10-3 has not been registered as a cooperative base station of the base station 10-1 (indicated by a “cross” in FIG. 4).

By referencing the cooperative base station management table 104-1 in which information such as described above is stored, the cooperative transmission control unit 103 of the base station 10-1 can recognize that the object of cooperation in the cooperative transmission processing is the base station 10-2.

### 1.2 Operations

Next, operations of the wireless communication system according to the embodiment will be described.

### 1.2.1 Negotiation Processing

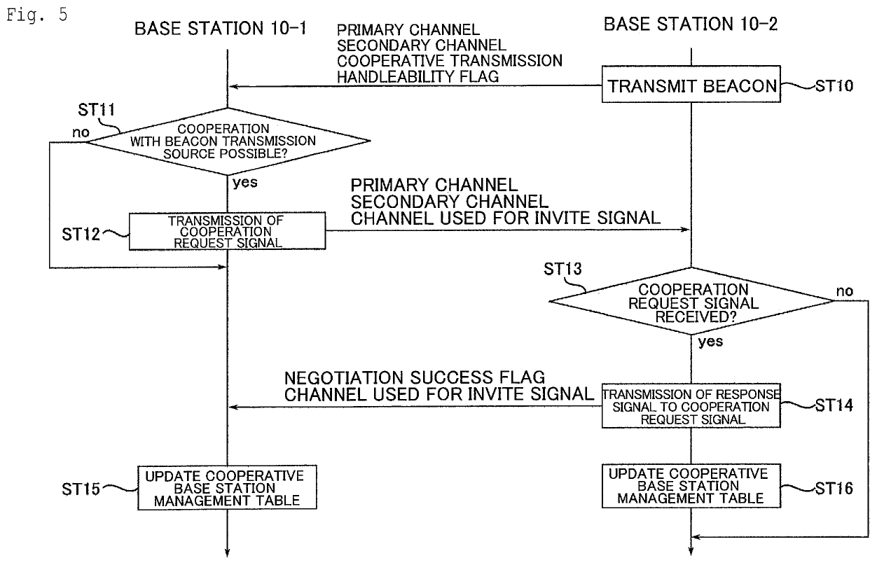

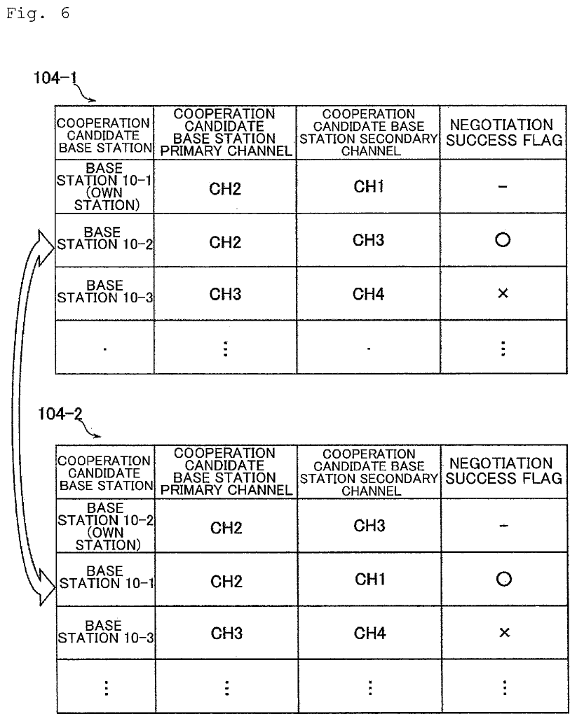

Negotiation processing among base stations according to the embodiment will be described by way of a flowchart shown in FIG. 5 and a conceptual diagram shown in FIG. 6.

In the example in FIG. 5, an example of a case of executing negotiation processing between the base station 10-1 and the base station 10-2 is shown. FIG. 6 shows the cooperative base station management table 104-1 in the base station 10-1, and a cooperative base station management table 104-2 in the base station 10-2, updated by the negotiation processing shown in FIG. 5.

Negotiation processing is executed in advance, prior to execution of the cooperative transmission processing.

As shown in FIG. 5, in step ST10, the base station 10-2 transmits a beacon. The beacon includes, for example, the address of the own station (base station 10-2), information indicating the primary channel and the secondary channel of the base station 10-2, and information indicating whether or not the base station 10-2 handles cooperative transmission processing (cooperative transmission handleability flag).

In step ST11, upon receiving the beacon transmitted from the base station 10-2 in step ST10, the base station 10-1 determines whether or not cooperation with the base station 10-2 that is the transmission source of the beacon is possible. Specifically, in a case in which the cooperative transmission handleability flag included in the beacon indicates handling cooperative transmission processing, and the primary channel of the base station 10-2 is the same as the primary channel of the base station 10-1, for example, the base station 10-1 determines that cooperation with the base station 10-2 is possible. Conversely, in a case in which the cooperative transmission handleability flag indicates not handling cooperative transmission processing, or the primary channel of the base station 10-2 is different from the primary channel of the base station 10-1, for example, the base station 10-1 determines that cooperation with the base station 10-2 is not possible. In a case of determining that cooperation with the base station 10-2 is possible (step ST11; yes), the processing of the base station 10-1 advances to step ST12, and a case of determining that cooperation with the base station 10-2 is not possible (step ST11; no), the processing of the base station 10-1 skips step ST12 and advances to step ST15.

In step ST12, the base station 10-1 generates a cooperation request signal, and performs transmission thereof to the base station 10-2. The cooperation request signal corresponds to a type of management frame, and the request signal includes, for example, information indicating the primary channel and the secondary channel of the base station 10-1, and information of the channel that the base station 10-1 uses for transmission of an invite signal. Any channel is selectable for the channel that the base station 10-1 uses for transmitting the invite signal, but the primary channel common to the base station 10-1 and the base station 10-2 may be selected, for example.

In step ST13, the base station 10-2 determines whether or not the cooperation request signal has been received. In a case in which the cooperation request signal has been received (step ST13; yes), the processing of the base station 10-2 advances to step ST14. Conversely, in a case in which the cooperation request signal has not been received (step ST13; no), the processing of the base station 10-2 skips steps ST14 and ST16 and ends.

In step ST14, the base station 10-2 generates a response signal to the received cooperation request signal, and performs transmission thereof to the base station 10-1. The response signal to the cooperation request signal corresponds to a type of management frame, and this response signal includes, for example, a negotiation success flag and information of the channel that the base station 10-2 uses for transmission of the invite signal. Any channel is selectable for the channel that the base station 10-2 uses for transmitting invite signal, but the primary channel common to the base station 10-1 and the base station 10-2 may be selected, for example.

In step ST15, the base station 10-1 updates the cooperative base station management table 104-1.

Specifically, the base station 10-1 stores information indicating the primary channel and the secondary channel of the base station 10-2 in the cooperative base station management table 104-1, on the basis of the information in the beacon received in step ST10.

Also, in a case of determining in step ST11 that cooperation with the base station 10-2 is not possible (step ST11; no), or in a case in which the negotiation success flag indicates failure in negotiation in step ST14, the base station 10-1 sets the negotiation success flag correlated with the base station 10-2 in the cooperative base station management table 104-1 to a “cross”. Conversely, in a case in which the negotiation success flag indicates success in negotiation in step ST14, the base station 10-1 sets the negotiation success flag correlated with the base station 10-2 in the cooperative base station management table 104-1 to a “circle”.

Accordingly, the results of negotiation processing with the base station 10-2 are stored in the cooperative base station management table 104-1 of the base station 10-1.

In step ST16, the base station 10-2 updates the cooperative base station management table 104-2. Specifically, in a case of transmitting a negotiation success flag indicating failure of negotiation processing in step ST14, the base station 10-2 sets a “cross” to the negotiation success flag correlated with the base station 10-1 in the cooperative base station management table 104-2. Also, in a case of transmitting a negotiation success flag indicating success of negotiation in step ST14, the base station 10-2 sets a “circle” to the negotiation success flag correlated with the base station 10-1 in the cooperative base station management table 104-2.

Accordingly, the results of the negotiation processing with the base station 10-1 are stored in the cooperative base station management table 104-2 of the base station 10-2.

Thus, the negotiation processing ends.

As illustrated in FIG. 6, upon negotiation succeeding between the two base stations 10-1 and 10-2, the base station 10-2 is registered as a cooperative base station in the cooperative base station management table 104-1 in the base station 10-1, and the base station 10-1 is registered as a cooperative base station in the cooperative base station management table 104-2 in the base station 10-2.

Note that the cooperative base station management tables 104-1 and 104-2 do not store which of the base stations 10-1 and 10-2 is the master station (or slave station). That is to say, the relation of the base stations 10-1 and 10-2 is that of equals in the period during the negotiation processing and after the negotiation processing ends, until one of the base stations 10-1 and 10-2 acquires the transmission right for the primary channel.

In the flowchart shown in FIG. 5, a case has been described in which the base station 10-1 transmits a cooperation request signal on the basis of the beacon that the base station 10-2 transmits, but this is not limiting. That is to say, the base stations 10-1 and 10-2 are configured to be able to alternate the roles of each other shown in FIG. 5 in the negotiation processing.

### 1.2.2 Transmission Processing

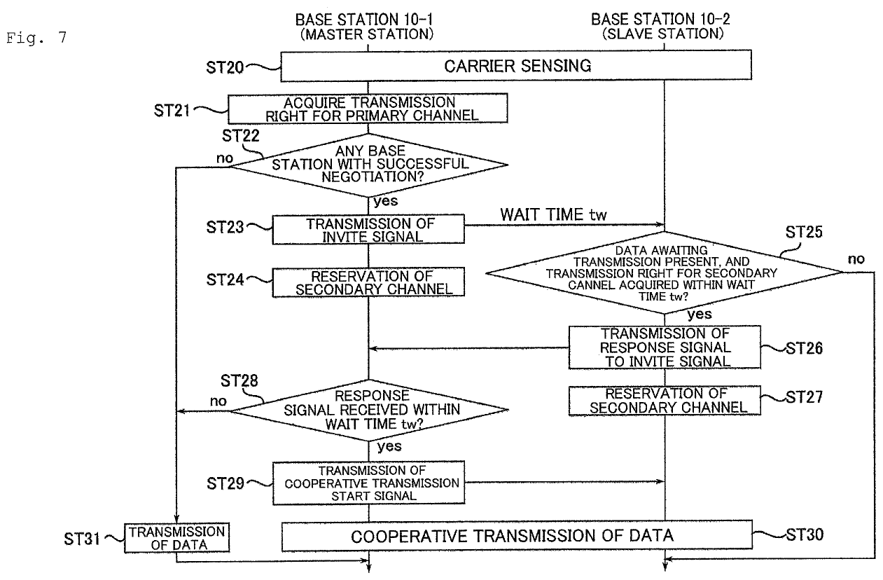

Next, transmission processing of data by a plurality of base stations according to the embodiment will be described with reference to the flowchart shown in FIG. 7. FIG. 7 shows an example of a case in which the base station 10-1 is the master station and the base station 10-2 is the slave station.

As shown in FIG. 7, in step ST20, the base stations 10-1 and 10-2 perform carrier sensing.

In step ST21, the base station 10-1 acquires the transmission right for the primary channel. The base station 10-2 that was not able to acquire the transmission right for the primary channel continues carrier sensing. From step ST21 onward, the base station 10-1 functions as the master station, and the base station 10-2 functions as the slave station.

In step ST22, the base station 10-1 references the cooperative base station management table 104-1, and determines whether or not there is a base station regarding which negotiation has already been successful. In a case in which there is a base station regarding which negotiation has already been successful (step ST22; yes), the processing advances to step ST23, and in a case in which there is no base station regarding which negotiation processing has already been successful (step ST22; no), the processing advances to step ST31.

In step ST23, the base station 10-1 generates an invite signal requesting participation in cooperative transmission processing, and performs transmission thereof, by a control frame for example, to the base station 10-2 regarding which determination is made that negotiation processing has already been successful. The invite signal includes, for example, time tw in which the base station 10-1 waits for a response from the base station 10-2. Also, the invite signal may include information indicating at least the primary channel, as information indicating the channel that the base station 10-1 will use for the cooperative transmission processing.

Also, in step ST24, in a case of having acquired the transmission right for the secondary channel of the base station 10-1, the base station 10-1 executes reservation processing for a TXOP (Transmission opportunity) period Ts_master to perform transmission using this secondary channel. The TXOP period Ts_master may be aligned with a TXOP period Tp regarding the primary channel. Specifically, the base station 10-1 transmits a CTS-to-self (Clear to Send) signal in which its own address is specified as the destination (CTS-to-self processing), for example. Thus, an NAV (Network Allocation Vector) can be set to the secondary channel of the base station 10-1, and other base stations 10 and so forth in the service area of the base station 10-1 can be suppressed from using the secondary channel of the base station 10-1. Note that the period reserved in the above-described reservation processing may be a period from the transmission of the invite signal until transmission of data.

Note that the base station 10-1 may execute the processing according to steps ST23 and ST24 in reverse order, or may perform execution thereof simultaneously.

Upon receiving the invite signal, in step ST25, the base station 10-2 determines whether or not participation in the cooperative transmission processing can be performed. Specifically, the base station 10-2 determines whether or not data awaiting transmission is present in the transmission queue. In addition, the base station 10-2 further determines whether or not the transmission right for the secondary channel of the base station 10-2 has been acquired as a result of the carrier sensing which has being continued from step ST20. Note that in this determination, even if a random backoff period remains at the time of receiving the invite signal, the base station 10-2 may assume the transmission right for the secondary channel to have been acquired if the secondary channel of the base station 10-2 is in an available state at that point in time. In a case in which there is data awaiting transmission, and the transmission right for the secondary channel of the base station 10-2 has been acquired (step ST25; yes), the processing of the base station 10-2 advances to step ST25. Conversely, in a case in which there no data awaiting transmission, or the transmission right for the secondary channel of the base station 10-2 has not been acquired (step ST25; no), the processing of the base station 10-2 skips steps ST26, ST27, and ST30, and ends.

In step ST26, the base station 10-2 generates a signal including information to the effect of participating in the cooperative transmission processing, as a response signal to the invite signal, and performs transmission thereof to the base station 10-1.

Also, in step ST27, the base station 10-2 executes reservation processing for TXOP period Ts_slave for performing transmission using the secondary channel of the base station 10-2. The TXOP period Ts_slave may be aligned with the TXOP period Tp and the Ts_master. Specifically, for example, the base station 10-2 can set a NAV to the secondary channel of the base station 10-2 by executing CTS-to-self processing. Thus, other base stations 10 and so forth in the service area of the base station 10-2 can be suppressed from using the secondary channel of the base station 10-2. Note that the period reserved in the above-described reservation processing may be a period from the transmission of the response signal to the invite signal until transmission of data.

Note that the base station 10-2 may execute the processing according to steps ST26 and ST27 in reverse order, or may perform execution thereof simultaneously.

In step ST28, the base station 10-1 determines whether or not the response signal to the invite signal has been received within the wait time tw from the transmission of the invite signal. In a case in which the response signal to the invite signal has been received within the wait time tw (step ST28; yes), the processing of the base station 10-1 advances to step ST29, and a case in which the response signal to the invite signal has not been received within the wait time tw (step ST28; no), the processing of the base station 10-1 advances to step ST31.

In a case in which the processing advances to step ST29, the base station 10-1 transmits a cooperative transmission start signal including information to the effect of starting cooperative transmission processing with the base station 10-2, to the base station 10-2.

In step ST30, the base stations 10-1 and 10-2 execute cooperative transmission processing of data. Specifically, the base station 10-1 and the base station 10-2 cooperate with each other in the frequency domain to transmit data by the primary channels of each and the secondary channel of the base station 10-2, respectively.

Conversely, in a case in which the processing advances to step ST31, the base station 10-1 executes transmission of data using the primary channel thereof, independent from the base station 10-2.

Thus, transmission processing of data ends.

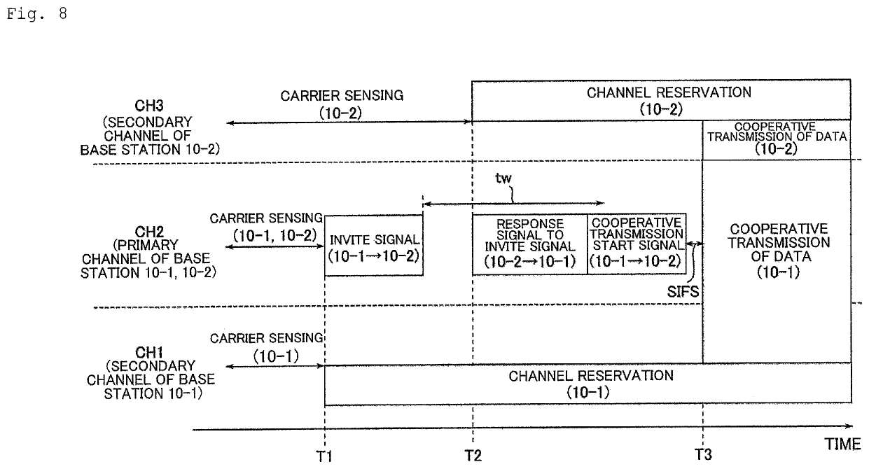

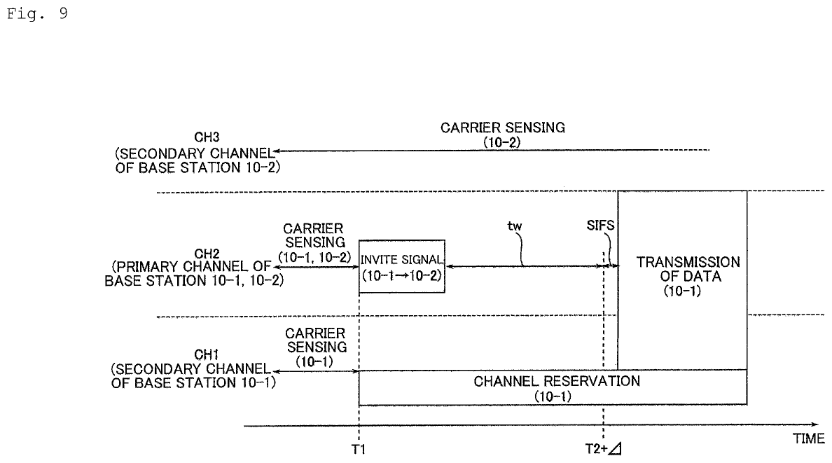

FIG. 8 and FIG. 9 are timing charts for describing transmission processing of data by a plurality of base stations according to the embodiment. In FIG. 8 and FIG. 9, operations on the three channels CH1, CH2, and CH3 by the base stations 10-1 and 10-2 in the flowchart described in FIG. 7 are shown on a time axis. FIG. 8 shows a timing chart in a case of executing cooperative transmission processing of data (step ST30 in FIG. 7). FIG. 9 shows a timing chart in a case of not executing cooperative transmission processing of data, and transmission processing is executed by the master station alone (step ST31 in FIG. 7). Note that FIG. 8 and FIG. 9 show examples of cases in which the cooperative base station management tables 104-1 and 104-2 shown in FIG. 6 are stored in the respective base stations 10-1 and 10-2.

First, a case in which cooperative transmission processing is executed will be described with reference to FIG. 8.

As shown in FIG. 8, carrier sensing of channels CH1 and CH2 by the base station 10-1, and carrier sensing of channels CH2 and CH3 by the base station 10-2, are executed.

At time point T1, the base station 10-1 acquires the transmission rights for the channel CH2 that is the primary channel, and the channel CH1 that is the secondary channel of the base station 10-1. In conjunction with this, the base station 10-1 uses channel CH2 to transmit an invite signal to the base station 10-2, and also executes reservation processing of the channel CH1 by CTS-to-self processing. The base station 10-1 sets in advance a reservation period Ts_master for the secondary channel, aligned with the TXOP period Tp of the primary channel, for example, and includes this in the CTS signal. Accordingly, the channel CH1 can be suppressed from being used for other communication until the cooperative transmission processing of the data is executed.

At time point T2, the base station 10-2 assumes that the transmission right for the channel CH3 that is the secondary channel of the base station 10-2 will be acquired, or that the transmission right has been acquired. In conjunction with this, the base station 10-2 uses the channel CH2 to transmit the response signal to the invite signal to the base station 10-1, and also executes reservation processing of the channel CH3 by CTS-to-self processing. The base station 10-2 sets the TXOP period Ts_slave for reservation of the channel CH3 in the CTS signal, on the basis of information indicating the TXOP period Ts_master included in the CTS signal transmitted at the time of the reservation processing of the channel CH1 by the base station 10-1. Accordingly, the channel CH3 can be suppressed from being used for other communication until the cooperative transmission processing of the data is executed.

Note that in the example in FIG. 8, the base station 10-2 transmits the response signal to the invite signal to the base station 10-1, within the wait time tw from the transmission of the invite signal. Accordingly, the base station 10-1 can determine that cooperative transmission processing is possible with the base station 10-2, and can transmit a cooperative transmission start signal to the base station 10-2.

The base stations 10-1 and 10-2 start cooperative transmission processing of data at a time point T3 following a SIFS (Short Inter Frame Space) after exchange of the cooperative transmission start signal is completed, for example. Specifically, data transmission processing by the base station 10-1 using the channels CH1 and CH2 in conjunction, and data transmission by the base station 10-2 using the channel CH3, are executed cooperatively in the frequency domain.

Next, a case in which cooperative transmission processing is not executed will be described with reference to FIG. 9.

As shown in FIG. 9, the acquisition of transmission rights, and transmission processing of the invite signal and the CTS signal by the base station 10-1 are the same as in the case of FIG. 8, and accordingly description will be omitted.

Meanwhile, in FIG. 9, at the time point (T2+Δ) at which the wait time tw from the transmission of the invite signal has elapsed, the base station 10-2 has not acquired the transmission right for the channel CH3 of the base station 10-2, or cannot assume that the transmission right has been acquired, unlike as in FIG. 8. In conjunction with this, the base station 10-2 does not transmit the response signal to the invite signal to the base station 10-1. Accordingly, at time point (T2+Δ), the base station 10-1 abandons cooperative transmission processing with the base station 10-2, and decides to execute data transmission alone. Specifically, the base station 10-1 executes data transmission processing using the channels CH1 and CH2 in conjunction after SIFS from the time point (T2+Δ), for example.

### 1.3 Effects According to Present Embodiment

In a case in which the base station 10-1 does not acquire the transmission right for the primary channel CH2, in order for the base station 10-2 to use the secondary channel CH3 and transmit wireless signals, the base station 10-2 is required to acquire the transmission right for this secondary channel CH3, and also acquire the transmission right for the primary channel CH1. This is because acquisition of the transmission right for the primary channel set in advance is required in the channel bonding specifications for transmitting wireless signals using a plurality of channels in conjunction. Thus, in a case in which the base station 10-1 does not acquire the transmission right for the primary channel CH2, the base station 10-2 cannot transmit wireless signals in a state in which the base station 10-2 has not acquired the transmission right for the primary channel CH2.

According to the present embodiment, in a case in which the base station 10-1 that is a cooperative base station of the base station 10-2 acquires the transmission right for the primary channel CH2, the base station 10-2, on the basis of acquiring the transmission right for the secondary channel CH3 of the base station 10-2, decides to transmit wireless signals using this secondary channel CH3. Accordingly, the base station 10-2 can transmit wireless signals over the secondary channel CH3 cooperatively with the base station 10-1, in a state in which the transmission right for the primary channel CH2 is not acquired. Thus, channels can be efficiently used between the base stations 10-1 and 10-2.

Also, the base station 10-1 receives wireless signals including information indicating the primary channel of the base station 10-2, and transmits wireless signals including information indicating the primary channel of the base station 10-1 to the base station 10-2. Accordingly, the base stations 10-1 and 10-2 can recognize that each other will use the same channel CH2 as the primary channel, prior to the cooperative transmission processing. Thus, when one base station out of the base stations 10-1 and 10-2 acquires the transmission right for the primary cannel CH2, an invite signal can be transmitted to the other base station, requesting participation in the cooperative transmission processing.

Note that generally, when transmission on the primary channel and reception on the secondary channel occur at the same time, power cross-leaking occurs with each other, and reception fails. According to the present embodiment, the TXOP period Ts_master and Ts_slave that the base stations 10-1 and 10-2 use for reservation periods of the secondary channel when the base stations 10-1 and 10-2 are a master station and a slave station respectively, are aligned with the TXOP period Tp on the primary channel. Thus, the problem of power cross-leaking does not occur, since the two channels are used for transmission at the same time at the master station side, and the possibility of reception occurring on the primary channel at the slave station side is also eliminated, and therefore occurrence of power cross-leaking can be suppressed.

### 2. Modifications, Etc

Note that various modifications can be made of the above-described embodiment.

For example, although a case of the two stations of the base station 10-1 and the base station 10-2 registering each other as cooperative base stations has been described in the above embodiment, this is not limiting, and three or more stations may register each other as cooperative base stations. In this case, the master station that has acquired the transmission right for the primary channel transmits invite signals to each of the plurality of slave stations. Each of the plurality of slave stations that have received the invite signals can determine whether or not to participate in the cooperative transmission processing on the basis of acquiring the transmission right for the secondary channel that each uses.

Now, in a case of the plurality of slave stations each using different secondary channels from each other, each of the plurality of slave stations can decide whether or not to participate in the cooperative transmission processing, independent of each other. Accordingly, the master station can execute cooperative transmission processing with at least one slave station that transmits a response signal to the invite signal to the master station.

Conversely, in a case in which the plurality of slave stations each using the same secondary channel, only one station out of the plurality of slave stations can acquire the transmission right for this secondary channel. Accordingly, the master station can execute the cooperative transmission processing with just the one slave station from which a response signal to the invite signal is received. Note that as described above, the wireless signal processing unit 102 can have a plurality of transmission queues including the transmission queue AC_LL. Accordingly, a slave station that has data awaiting transmission in a transmission queue to which access parameters with a higher degree of priority are set can more readily participate in cooperative transmission processing.

Note that in a case of three or more stations registering each other as cooperative base stations, the reservation period for the secondary channel may be set for a period prior to transmitting data with priority, rather than the TXOP period. Accordingly, in a case of reservations signals for the secondary channel being transmitted from a plurality of slave stations, for example, reservation signals of slave stations that were not able to acquire transmission rights can be suppressed from obstructing communication of other base stations.

Each of the processing in the embodiment described above can also be stored as a program that can be executed by a processor that is a computer. Additionally, storage thereof in a storage medium of an external storage device such as a magnetic disk, an optical disk, semiconductor memory, and so forth, may be performed, and distribution may be performed. The processor can then execute the above-described processing by reading in the program stored in the storage medium of the external storage device, and actions thereof being controlled by the program read in.

Note that the present invention is not limited to the above embodiment, and various modifications can be made at the stage of carrying out without departing from the essence thereof. Also, the embodiments may be combined and carried out as appropriate, and in this case, combined effects are obtained. Further, the above embodiment includes various types of inventions, and various inventions can be extracted by combination of selected sets of a plurality of disclosed components. For example, in a case in which the problem can be solved and effects can be obtained even though several components are omitted from all components shown in the embodiment, the configuration in which these components are omitted can be extracted as an invention.

### REFERENCE SIGNS LIST

1 Wireless communication system
10-1, 10-2, 10-3 Base station
11 Processor
12 ROM
13 RAM
14 Wireless module
15 Router module
20 Terminal apparatus
101 Data processing unit
102 Wireless signal processing unit
103 Cooperative transmission control unit
104 Cooperative base station management table

1. A base station serving as a second base station comprises a wireless signal processing unit capable of using a first channel held in common with another base station serving as a first base station,
wherein the wireless signal processing unit is configured to execute first cooperative processing in a case of the first base station acquiring a transmission right for the first channel that is a primary channel,
and wherein the first cooperative processing includes, on the basis of the second base station acquiring a transmission right for a second channel that is a secondary channel of the second base station, deciding to transmit by the second channel.

2. The base station according to claim 1,
wherein the first cooperative processing includes transmitting, by the second channel, a second signal cooperating with the first base station transmitting a first signal by the first channel.

3. The base station according to claim 2,
wherein the first cooperative processing includes reserving transmission by the second channel in a period up to completion of transmission of the second signal.

4. The base station according to claim 2,
wherein the wireless signal processing unit is configured to, in a case of the second base station acquiring the transmission right for the first channel, execute second cooperative processing,
and wherein the second cooperative processing includes transmitting, by the first channel, a fourth signal cooperating with the first base station transmitting a third signal by a third channel.

5. The base station according to claim 4,
wherein the second cooperative processing includes reserving transmission by the first channel in a period up to completion of transmission of the fourth signal.

6. The base station according to claim 4,
wherein the wireless signal processing unit is configured to transmit, to the first base station, a fifth signal including information indicating whether or not the second base station handles the first cooperative processing and the second cooperative processing.

7. The base station according to claim 4,
wherein the wireless signal processing unit is configured to
transmit, upon receiving from the first base station a fifth signal including information indicating whether or not the first base station handles the first cooperative processing and the second cooperative processing, a sixth signal requesting negotiation relating to the first cooperative processing and the second cooperative processing, to the first base station, and
determine whether or not negotiation with the first base station is possible, on the basis of a seventh signal responding to the sixth signal.

8. A communication method of a base station, the method comprising:
in a case of another base station serving as a first base station acquiring a transmission right for a first channel that is a primary channel held in common with the base station serving as a second base station, the second base station deciding, on the basis of acquiring a transmission right for a second channel that is a secondary channel of the second base station, to transmit by the second channel.

9. A non-transitory computer-readable storage medium storing a communication program used in a base station serving as a second base station, the program causing a computer to
in a case of another base station serving as a first base station acquiring a transmission right for a first channel that is a primary channel held in common with the second base station, cause the second base station to decide, on the basis of acquiring a transmission right for a second channel that is a secondary channel of the second base station, to transmit by the second channel.
